(19) United States
(12) Patent Application Publication
(10) Pub. No.: US 2019/0053666 A1
(43) Pub. Date: Feb. 21, 2019

(54) PORTABLE FIRE PIT SYSTEM

(71) Applicant: Greg Jones Hofer, Victoria (CA)

(72) Inventor: Greg Jones Hofer, Victoria (CA)

(21) Appl. No.: 15/679,749

(22) Filed: Aug. 17, 2017

(51) Int. Cl. A47J 37/07; F24B 3/00

(52) U.S. Cl. CPC A47J 37/0763; F24B 3/00

(57) ABSTRACT

A portable fire pit system provides a portable fire pit that uses skis. The portable fire pit system may include a frame assembly having a fire pit, a platform supporting the fire pit, and a pair of skis supporting the fire pit and the platform. The pair of skis are positioned along a length of the platform parallel to one another on opposing sides of the platform. The portable fire pit system is moveable via sliding and configured to provide a portable all terrain fire pit.

The following includes information that may be useful in understanding the present disclosure. It is not an admission that any of the information provided herein is prior art nor material to the presently described or claimed inventions, nor that any publication or document that is specifically or implicitly referenced is prior art.

### BACKGROUND OF THE INVENTION

### 1. Field of the Invention

The present invention relates generally to the field of fire pits and more specifically relates to a portable fire pit.

### 2. Description of Related Art

Many people enjoy an open, outdoor fire, such as at a campground. For many outdoor enthusiasts, whether they be fishing, hunting, snowmobiling, travelling on all-terrain-vehicles, or exploring, fires are often made as a means of staying warm or preparing food. If this is during a cold winter, the fire is often started on the snow or ice. The heat from the fire then melts the snow or ice into water, thereby extinguishing the fire. If the fire is made during a warm season, the problem becomes preventing the fire from spreading to the surrounding environment. To avoid these problems, a fire pit is required. Such fire pits are cumbersome to carry or transport. A suitable solution is desired.

U.S. Pub. No. 2009/0107483 to Christian Fitzgerald, et al. relates to a portable fire pit. The described portable fire pit includes a portable fire pit having a base for supporting and containing combustible material, a plurality of legs for supporting the base above the ground or other surface, and a plurality of fire screens movably mounted to the base for movement between a first, compact position for transport and storage of the portable fire pit and a second, extended position in which the screens are substantially upright to contain the fire. Each of the fire screens comprises a frame and a wire screen mounted therein. Additionally, the fire screens are movably mounted to the base using sliding hinges and guides such that in the second, extended position the fire screens are maintained in the upright position by the guides.

### BRIEF SUMMARY OF THE INVENTION

In view of the foregoing disadvantages inherent in the known fire pits art, the present disclosure provides a novel portable fire pit system. The general purpose of the present disclosure, which will be described subsequently in greater detail, is to provide a portable fire pit that uses skis for means of transport between locations.

A portable fire pit system is disclosed herein. The portable fire pit system includes a frame assembly having a fire pit, a platform supporting the fire pit, and a pair of skis supporting the fire pit and the platform. The pair of skis are positioned along a length of the platform parallel to one another on opposing sides of the platform. In certain embodiments, the frame assembly may comprise storage racks configured to store at least one item. The platform is generally rectangular profile with the fire pit positioned in a center potion of the platform. The portable fire pit system is towable and configured to provide a portable all terrain fire pit. The device may provide an ice fishing firepit that will allow a user to have a fire on ice and move the fire when desired.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a portable fire pit system, constructed and operative according to the teachings of the present disclosure.

FIG. 1 is a perspective view of the portable fire pit system during an ‘in-use’ condition, according to an embodiment of the disclosure.

FIG. 2A is a perspective view of the portable fire pit system of FIG. 1, according to an embodiment of the present disclosure.

FIG. 2B is a perspective view of the portable fire pit system of FIG. 1, according to an embodiment of the present disclosure.

FIG. 2C is a perspective view of the portable fire pit system of FIG. 1, according to an embodiment of the present disclosure.

FIG. 3 is a perspective view of the portable fire pit system of FIG. 1, according to an embodiment of the present disclosure.

FIG. 4 is a perspective view of the portable fire pit system of FIG. 1, according to an embodiment of the present disclosure.

FIG. 5A is a perspective view of the portable fire pit system of FIG. 1, according to an embodiment of the present disclosure.

FIG. 5B is a perspective view of the portable fire pit system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a fire pits and more particularly to a portable fire pit system as used to improve the portability and use of a fire pit.

Generally, the portable fire pit system is a portable fire pit that uses skis instead of wheels. The device is ideal for ice fisherman but can be used year-round in all environments. The portable fire pit system is a portable fire pit that is ideal for winter use, providing an excellent ice fishing firepit that will allow a user to have a fire on ice that won't leave a ‘mess’ on the ice. When the fire starts to melt the snow or the top layer of ice it can be moved easily which will prevent a water hole being formed around your fire. This becomes a slipping hazard, and having the ability to move your fire will prevent this.

Portable fire pit system allows the user to have a fire that will be safer for children to be around and may include the option to attach a grill on top to prepare a lunch or a hot drink out in the cold. The device may also be used in the back yard or out camping. A tow rope may be attached to the portable fire pit system for moving the fire to a new location. Storage racks may be included for stowing a cooler, cooking items or wood. The gear may be secured with some sort of rope or strap. Once the fire is lit then the gear will need to be moved by other means if the fire is burning.

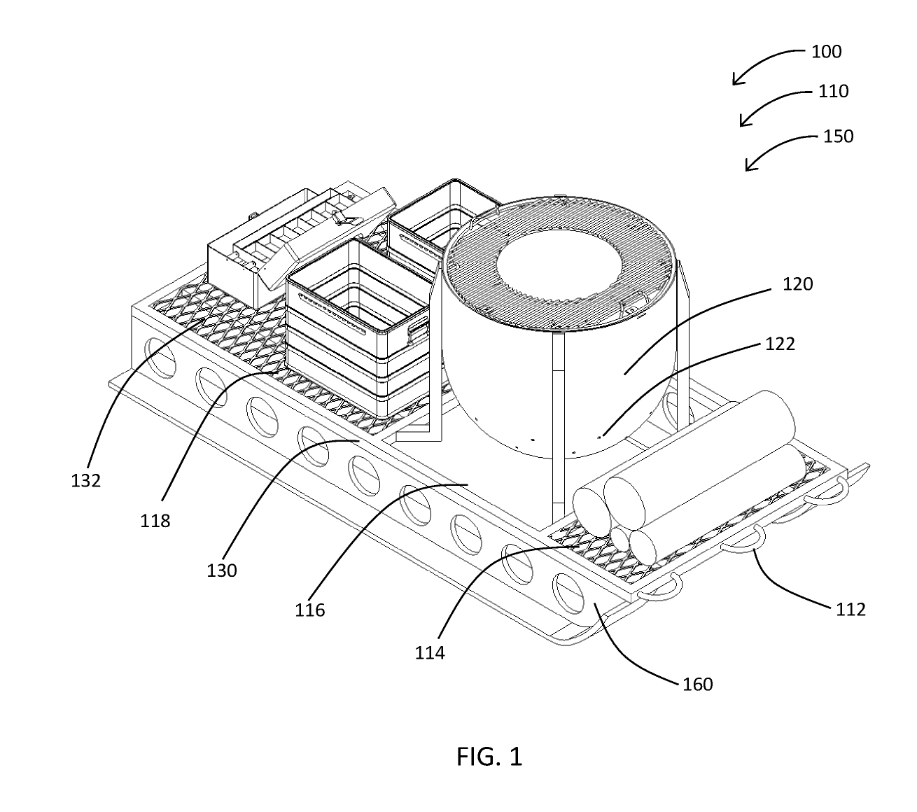

Referring now more specifically to the drawings by numerals of reference, there is shown in FIGS. 1-5B, various views of a portable fire pit system 100. FIG. 1 shows a portable fire pit system 100 during an ‘in-use’ condition 150, according to an embodiment of the present disclosure. As illustrated, the portable fire pit system 100 may include a frame assembly 110 having a fire pit 120, a platform 130 supporting the fire pit 120, and a pair of skis 160 supporting the fire pit 120 and the platform 130. The pair of skis 160 are positioned along a length of the platform 130 parallel to one another on opposing sides of the platform 130. The portable fire pit system 100 is moveable via sliding and configured to provide a portable all terrain fire pit 120.

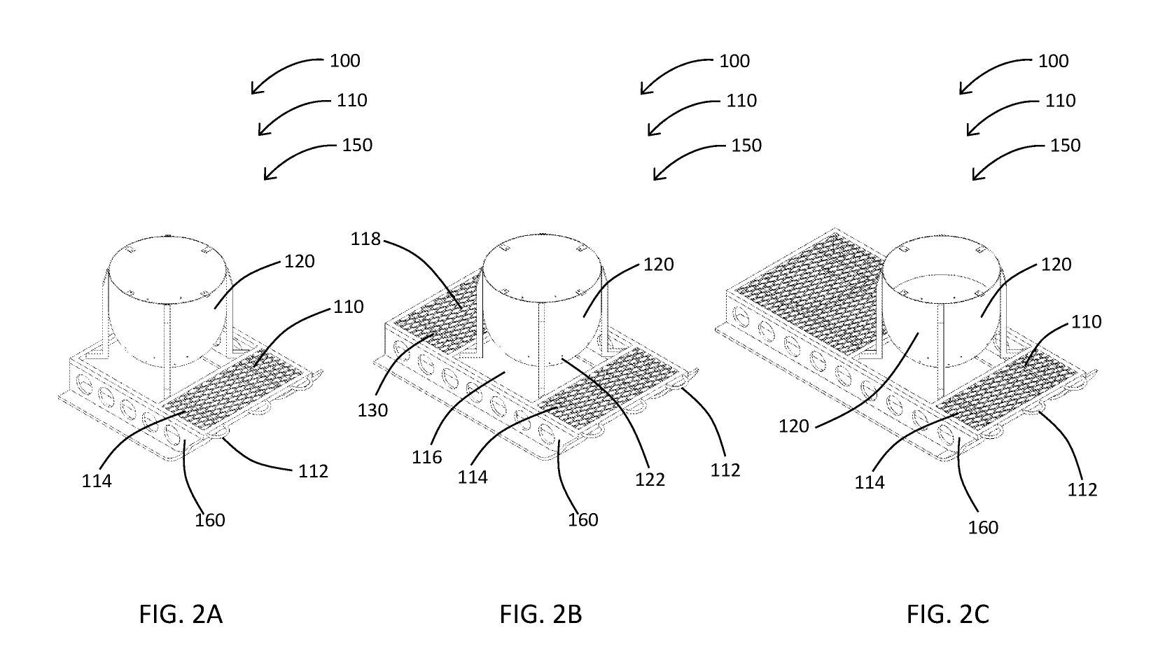

FIG. 2A-2C show perspective views of the portable fire pit system 100 of FIG. 1, according to an embodiment of the present disclosure. As above, the portable fire pit system 100 may include the frame assembly 110 including the fire pit 120, the platform 130 supporting the fire pit 120, and the pair of skis 160. Various sizes of the portable fire pit system 100 may be included. In certain embodiments, the frame assembly 110 may further comprise storage racks configured to store at least one item. The platform 130 comprises a generally rectangular profile with the fire pit 120 positioned in a center potion of the platform 130 separating the platform 130 into three sections including a front-section 114, a fire-pit-section 116, and a rear-section 118. The frame assembly 110 further comprises at least one towing handle 112 positioned at a front end of the front-section 114 of the platform 130. The frame assembly 110 may include three of the towing handles 112 positioned at a front end of the front-section 114 of the platform 130. A plurality of support beams 132 support and reinforce the front-section 114 and the rear-section 118 of the platform 130 relative to each other.

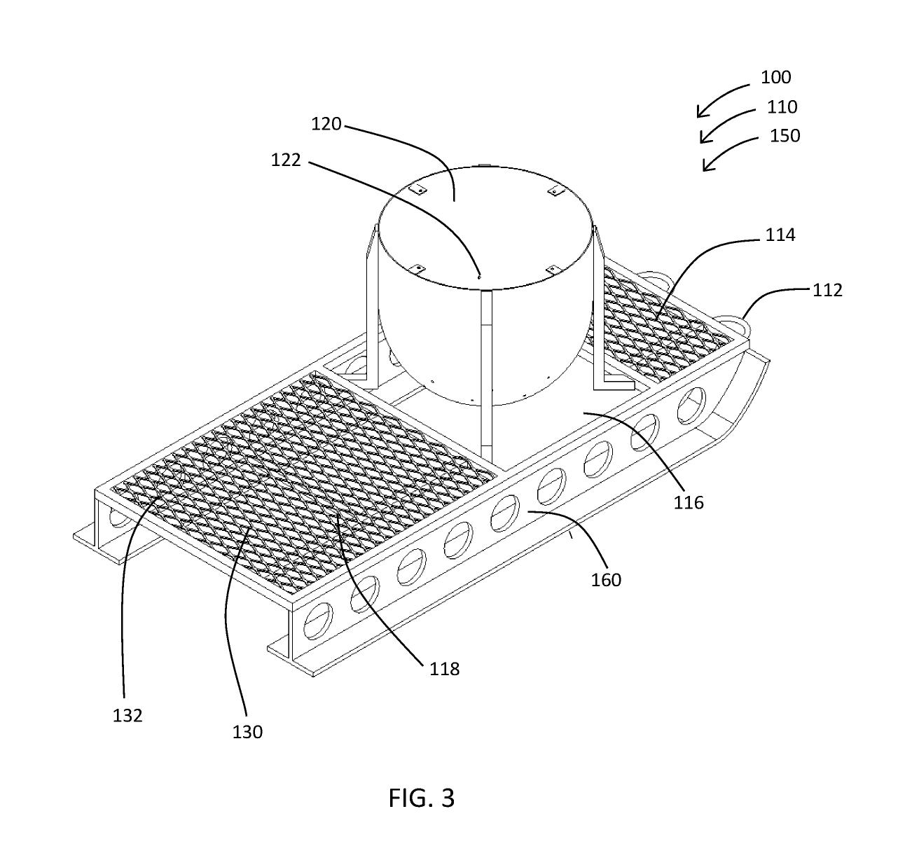

FIG. 3 shows a perspective view of the portable fire pit system 100 of FIG. 1, according to an embodiment of the present disclosure. As above, the portable fire pit system 100 may include the frame assembly 110 including the fire pit 120, the platform 130 supporting the fire pit 120, and the pair of skis 160 for transporting the fire pit 120 and the platform 130 across snow, ice or other terrain. The platform 130 may comprise a grate-like material. The fire pit 120 comprises apertures 122 configured for air to pass therethrough. The apertures 122 may comprise a diameter of approximately 1-inch allowing for heat to be dispersed around the fire. The fire pit 120 may be situated in an elevated or non-elevated position in relation to the platform 130. In a non-elevated position above the platform 130 a single plane is created.

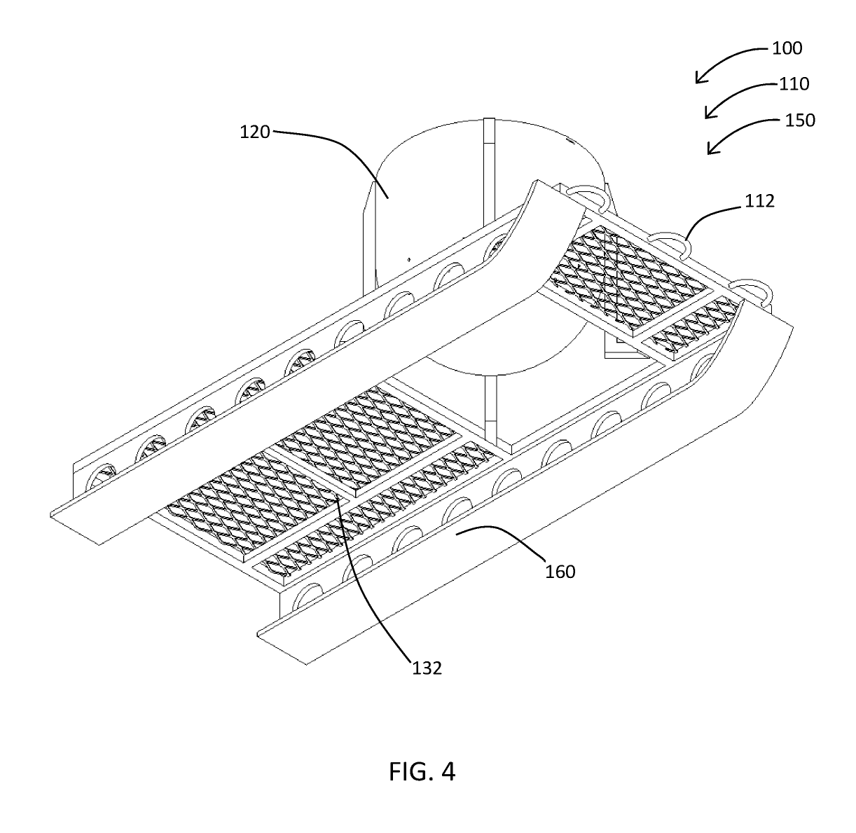

FIG. 4 shows a perspective view of the portable fire pit system 100 of FIG. 1, according to an embodiment of the present disclosure. As above, the portable fire pit system 100 may include the frame assembly 110 including the fire pit 120, the platform 130 supporting the fire pit 120, and a pair of skis 160 supporting the fire pit 120 and the platform 130. The fire pit 120 may comprise a bowl profile having an open top-end. In a preferred embodiment, the open-end of the fire pit 120 has a diameter of approximately 20 inches and a depth of approximately 18 inches. The frame assembly 110 comprises durable ferrous material. The frame assembly 110 comprises a plurality of legs for supporting the platform and the fire pit in an elevated position above the pair of skis.

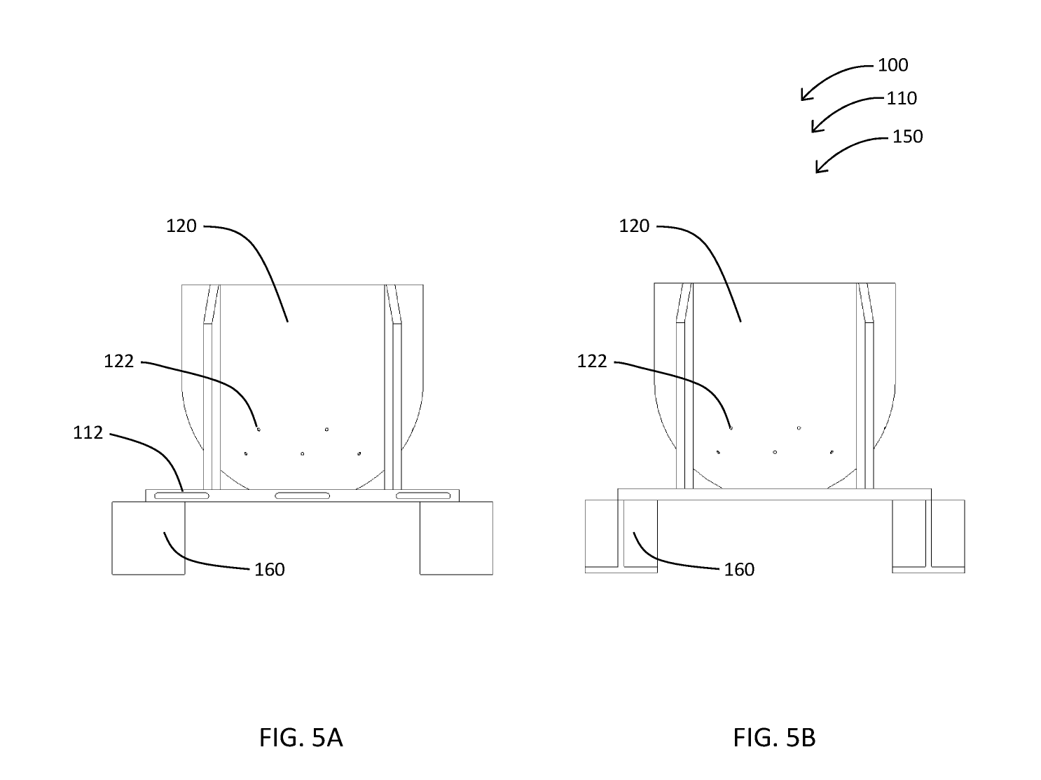

FIGS. 5A and 5B show perspective views of the portable fire pit system 100 of FIG. 1, according to an embodiment of the present disclosure. As above, the portable fire pit system 100 may comprise the frame assembly 110 including the fire pit 120, the platform 130 supporting the fire pit 120, and the pair of skis 160. In a preferred embodiment, the pair of skis 160 comprise a ski-length approximately equal to a length of the platform 130. The pair of skis 160 may comprise a width of approximately 6-inches and are configured to provide means to transport the portable fire pit system 100 across ground-terrain and covered ground-terrain. The platform 130 may be approximately 26-inches wide and 60-inches long. The platform 130 may be separated into three sections including the front-section 114, the fire-pit-section 116, and the rear-section 118. The frame assembly 110 may be provided in a variety of sizes including 32-inches, 46-inches, 60-inches, or other suitable sizes. The height of the device having an elevated fire pit 120 may be 24-inches. The platform 130 height may be 6-inches measuring from a ground surface to the top of the platform 130. The fire pit 120 may further include a grill attachment and means for attaching the grill attachment to the fire pit 120.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A portable fire pit system, the portable fire pit system comprising:
a frame assembly;
a fire pit;
a platform supporting said fire pit; and
a pair of skis supporting said fire pit and said platform;
wherein said pair of skis are positioned along a length of said platform parallel to one another on opposing sides of said platform; and
wherein said portable fire pit system is moveable via sliding and is configured to provide a portable all terrain said fire pit.

2. The portable fire pit system of claim 1, wherein said platform comprises a grate.

3. The portable fire pit system of claim 1, wherein said fire pit comprises apertures configured for air to pass therethrough.

4. The portable fire pit system of claim 3, wherein said apertures comprise a diameter of approximately 1-inch.

5. The portable fire pit system of claim 1, wherein said fire pit is situated in an elevated position above said platform.

6. The portable fire pit system of claim 1, wherein said fire pit is configured in a non-elevated position above said platform creating a single plane.

7. The portable fire pit system of claim 1, wherein said frame assembly further comprises storage racks configured to store at least one item.

8. The portable fire pit system of claim 1, wherein said platform comprises a generally rectangular profile with said fire pit positioned in a center potion of said platform separating said platform into three sections including a front-section, a fire-pit-section, and a rear-section.

9. The portable fire pit system of claim 1, wherein said frame assembly further comprises at least one towing handle positioned at a front end of said front-section of said platform.

10. The portable fire pit system of claim 9, wherein said frame assembly comprises three of said at least one towing handle positioned at a front end of said front-section of said platform.

11. The portable fire pit system of claim 1, wherein a plurality of support beams support and reinforce said front-section and said rear-section of said platform relative to each other.

12. The portable fire pit system of claim 1, wherein said fire pit comprises a bowl profile having an open top-end.

13. The portable fire pit system of claim 12, wherein said fire pit comprises a diameter of approximately 20 inches and a depth of approximately 18 inches.

14. The portable fire pit system of claim 1, wherein said frame assembly comprises ferrous material.

15. The portable fire pit system of claim 1, wherein said frame assembly comprises a plurality of legs for supporting said platform and said fire pit in an elevated position above said pair of skis.

16. The portable fire pit system of claim 1, wherein said pair of skis comprise a ski-length approximately equal to a length of said platform.

17. The portable fire pit system of claim 16, wherein said pair of skis each comprise a width of approximately 6-inches and are configured to provide means to transport said portable fire pit system across ground-terrain and covered said ground-terrain.

18. The portable fire pit system of claim 1, wherein said platform is approximately 26-inches wide and 60-inches long.

19. The portable fire pit system of claim 1, wherein said fire pit further comprises a grill attachment and means for attaching said grill attachment to said fire pit.

20. A portable fire pit system, the portable fire pit system comprising:
a frame assembly;
a fire pit;
a platform supporting said fire pit; and
a pair of skis supporting said fire pit and said platform;
wherein said pair of skis are positioned along a length of said platform parallel to one another on opposing sides of said platform;
wherein said platform comprises a grate;
wherein said fire pit comprises apertures configured for air to pass therethrough;
wherein said apertures comprise a diameter of approximately 1-inch;
wherein said fire pit is situated in an elevated position above said platform;
wherein said fire pit comprises a bowl profile having an open top-end;
wherein said platform comprises a generally rectangular profile with said fire pit positioned in a center potion of said platform separating said platform into three sections including a front-section, a fire-pit-section, and a rear-section;
wherein a plurality of support beams support and reinforce said front-section and said rear-section of said platform relative to each other;
wherein said frame assembly further comprises at least one towing handle positioned at a front end of said front-section of said platform;
wherein said frame assembly comprises ferrous material;
wherein said frame assembly comprises a plurality of legs for supporting said platform and said fire pit in an elevated position above said pair of skis;
wherein said pair of skis comprise a ski-length approximately equal to a length of said platform;
wherein said pair of skis each comprise a width of approximately 6-inches and are configured to provide means to transport said portable fire pit system across ground-terrain and covered said ground-terrain; and
wherein said portable fire pit system is moveable via sliding and configured to provide a portable all terrain said fire pit.
